(19) United States
(12) Patent Application Publication
(10) Pub. No.: US 2021/0153460 A1
(43) Pub. Date: May 27, 2021

(54) DEVICE FOR PROTECTING PAWS

(71) Applicant: Brigitte Engelmayer, Wels (AT)

(72) Inventor: Franz Vesztergom, Wels (AT)

(73) Assignee: Brigitte Engelmayer, Wels (AT)

(21) Appl. No.: 16/633,154

(22) PCT Filed: Jul. 13, 2018
(86) PCT No.: PCT/AT2018/000064

§ 371 Date: Jan. 22, 2020

(30) Foreign Application Priority Data
Jul. 25, 2017 (AT) A 50621/2017

(51) Int. Cl. A01K 13/00

(52) U.S. Cl. CPC A01K 13/007

(57) ABSTRACT

A device for protecting paws is described, with an upper part and a lower part which each have a shank portion and a paw portion which are connected to each other in sections at the edges so as to form a shank and a paw holder adjoining the shank. In order to configure a device of the type described at the beginning in such a manner that secure paw protection for digitigrades, in particular for dogs, is made possible without substantially interfering here with the natural sequence of movement or the sense of feel on the undersides of the paws, it is proposed that the paw portion of the lower part is in the form of a semi-oval shape adjoining, along the transverse axis thereof, the shank portion of the lower part, and the paw portion of the upper part is in the form of a semi-oval shape adjoining, along the longitudinal axis thereof, the shank portion of the upper part.

### CROSS-REFERENCE TO RELATED APPLICATIONS

This application is a National Stage Application of International Application No. PCT/AT2018/000064, filed Jul. 13, 2018, which claims benefit to Austrian Application No. A 50621/2017, filed Jul. 25, 2017, which are incorporated by reference herein in their entireties.

### SUMMARY

The invention relates to a device for protecting paws including an upper part and a lower part, each having a shank portion and a paw portion, wherein the upper and lower parts are connected in sections at the edges, forming a shank and a paw holder adjacent to the shank.

For the purpose of protecting the paws of animals, particularly dogs, boots are known (U.S. Pat. No. 5,495,828 A) which consist of an upper part and a lower part which are sewn together at the edges, forming a paw holder. In order to avoid slip-off of such a boot, a circumferential closing fastener at a certain distance from the opening of the paw holder is provided.

Similar embodiments are shown in US 2014360053 A, US 2011041779 A, and WO 09120723 A2, wherein all known devices for the protection of animal paws are modelled after shoes or gloves for humans and thus do not sufficiently take into consideration the special anatomical features of animals, in particular dogs. One disadvantage of known devices is that they interfere with the very sensitive sense of feel located on the underside of paws due to the specific anatomical characteristics of digitigrades.

The present invention is thus tasked with configuring a device as described above with the aim of enabling secure paw protection for digitigrades, particularly dogs, without interfering significantly with the natural sequence of movement or the sense of feel on the undersides of the paws.

The present invention solves this problem by configuring the paw portion of the lower part in semi-oval shape adjoining, along the transversal axis thereof, the shank portion of the lower part, and the paw portion of the upper part in semi-oval shape adjoining, along the longitudinal axis thereof, the shank portion of the upper part. This means that the two longitudinal axes of the semi-ovals of the upper and lower parts as well as the two transversal axes of the semi-ovals of the upper and lower parts are perpendicular with respect to one another, such that the semi-oval of the lower part has a more pronounced curvature than the semi-oval of the upper part. The semi-ovals are preferably substantially symmetrical as regards their longitudinal and transversal axes. Based on these features, in a closed state of the device of the invention the paw portion of the lower part and the shank portion of the lower part are at an angle of approximately 25° to 40°, wherein the paw portion of the lower part between the transition area to the shank portion of the lower part and the front limit by the semi-oval is concavely curved inwardly and thus adjusts to the paw form in order to promote the sense of feel. A particularly favourable adjustment to the paw form can be achieved by configuring the transversal axes of the semi-ovals of the lower and upper parts to be approximately the same length and the longitudinal axes of the semi-ovals of the lower and upper parts in a ratio of 1.1 to 1.25. This results in an angle of 30° to 35° between the paw portion of the lower part and the shank portion of the lower part. Particularly simple construction conditions are to be achieved by configuring the semi-ovals as semi-ellipses each.

To avoid wrong running movements or even a twist of the paw into the wrong direction during wear of the paw protection, the invention allows for a configuration in which both semi-ovals are arranged symmetrically with respect to the shank axis, and the semi-oval adjoining, along the longitudinal axis thereof, the shank portion of the upper part has, at the end of its transversal axis facing away from the shank portion, an end portion tapered to form an apex. This is why, for the purpose of the present invention, the term “semi-oval” is meant to include all those forms having an end portion tapered to form an apex, particularly as physically such end portions are continuously multiply differentiable, too. As a consequence, the paw holder curves slightly upwards in the front end portion thereof facing away from the shank, so as to guarantee that, during running movements, it is always the lower part that comes into bearing contact with the ground, and to avoid rolling-over on to the upper part of the device.

In order to guarantee the above-mentioned curvature properties of the paw holder, the shank portion of the upper part according to the invention may have a reinforcement. Said reinforcement may, for example, be in form of an at least sectional redoubling of material or may be effected by the use of different materials that show higher flexural strength.

To avoid the formation of folds in this context while at the same time keeping the total weight of the device to a minimum, it is suggested to have the shank portion of the upper part penetrated by an oval which is closed off by a cover part circumferentially resting on the upper part as reinforcement and which is, in the area of the end portions of the longitudinal and transversal axes thereof, complemented by cut-outs in the shank portion of the upper part. Said cut-outs in the area of the end portions of the longitudinal and transversal axes thereof avoid material force peaks in case of a curvature and thus prevent the formation of folds in these areas so that no pressure points occur on the one hand and the longevity of the paw protection according to the invention is improved on the other hand.

In this context it has been found to be advantageous for the cover part to have a vent opening sealed with a breathable membrane. Said vent opening may consist of a single opening or a plurality of smaller openings. Venting the paw protection is essential if the material used is not breathable or breathable to a limited extent. In order to prevent water or other liquids from entering the device for protecting paws, the membrane may for example be configured in a liquid-tight manner. To avoid the unintentional formation of folds in case of a vent opening, said vent opening may, in a particularly advantageous configuration of the device, not include one big opening, but rather a plurality of smaller openings scattered over the cover part, which affect the bending properties of the material used to a significantly lower extent.

To enable a device for protecting paws according to the invention to be easily adjusted to paw size, it is suggested to have two tension fasteners connecting the upper part to the lower part located in the area of the open shank end on the outside of the shank. Said tension fasteners may, for example, be configured to be hook-and-loop fasteners. When closing the tension fasteners, the lateral transitional area between upper part and lower part may be folded to form a fold so that the material of the upper and lower parts, which has been folded laterally to form a fold, may function as a spring which enables improved freedom of movement while at the same time guaranteeing a good fit. Reinforcement of the upper part prevents the material of the upper and lower parts laterally folded to form a fold from causing the formation of a fold in the area of the paw holder. In order to be able to exchange the tension fasteners separately from the rest of the device according to the invention in case of wear, it is suggested that the tension fasteners each comprise a fully removable loop strip as well as hook strips adhered to the upper or lower parts.

To guarantee a good fit as well as prevent accidental slip-off of the paw protection, the shank portion of the lower part may be extended beyond the open shank end toward a slip-off protection, which in closed position is tapered conically away from the shank. Said slip-off protection may consist of a base part, from which two wing-shaped closing parts are protruding outwards, which may be closed around the paw by forming a conus tapered away from the shank. Although the actual wing form is not a prerequisite, especially advantageous conditions may be achieved when, in closed state, the closing parts are level with the base part in an upward direction, i.e. on the side of the slip-off protection facing away from the shank, to avoid rubbing in this area. The closing parts may have a hook-and-loop fastener in the end portions thereof in order to connect both closing parts with one another and, in an especially preferred embodiment, with a respective connecting part of the shank portion of the upper part, wherein the connecting part may also be equipped with a hook-and-loop fastener to that purpose. To avoid the formation of folds and wear and tear in this area as well, the edge portions of the slip-off protection at the transition to the shank portion of the lower part may be configured to particularly have circular-shaped cut-outs. This is because, depending on the material selected for the device according to the invention, the material is under risk of tear at end areas which are under particular mechanical stress. To prevent the former, such end areas may either be relieved by punch-outs, if these are tapered edge portions, or they may be protected by a material reinforcement, such as adhered end strips. Such protection may also be achieved by configuring individual components of the device, such as the slip-off protection, in a way that they are not formed integrally but consist of a plurality of adhered single parts, which prevents tear of the used material at adhesion locations.

In order to improve the effect of the slip-off protection, said slip-off protection may in sections on the inside be equipped with a non-slip coating which also serves as rubbing protection.

As concerns the selection of material for the paw protection according to the invention, a balance between flexional elasticity or flexural strength, elasticity and the resulting protection effect is essential. These parameters are easily adjustable when forming the upper and lower parts from polyurethane foam. Furthermore, polyurethane has water-resistant and acid-resistant properties and to a certain extent also provides sting protection, which is why the paw protection according to the invention, with the exception of the fastening elements, may advantageously be made entirely from polyurethane foam. In this context, especially advantageous properties are achieved with polyurethane foam which, at a material thickness of 1-3 mm, especially 2.5 mm, has a tensile strength of about 8.1 N/mm², measured according to DIN 53504. Such a polyurethane foam may have a shore hardness of 35 Sh/A, measured according to DIN 53505, to provide sufficient protection from injuries.

### BRIEF DESCRIPTION OF THE DRAWINGS

The figures provide an exemplary illustration of the subject of the invention.

FIG. 1 shows a planar view of the device according to the invention in an opened state,

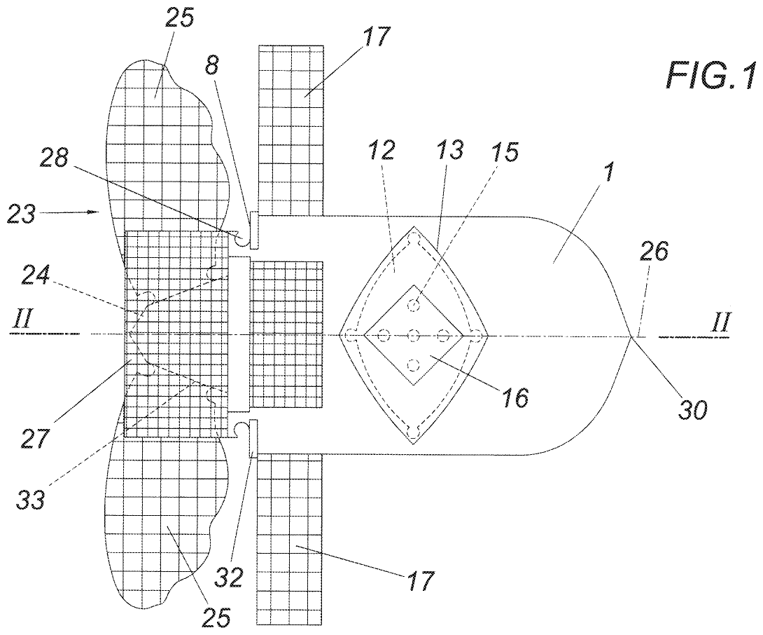

FIG. 2 shows a larger-scale cross-section along the line II-II of FIG. 1,

FIG. 3 shows a view corresponding to FIG. 1 of the device in a closed state,

FIG. 4 shows a larger-scale cross-section along the line IV-IV of FIG. 3, and

FIG. 5 shows a schematic view of the cutting templates of the upper and lower parts in order to better explain geometric ratios.

### DETAILED DESCRIPTION

A device for protecting paws according to the invention comprises an upper part 1 and a lower part 2, which are connected in sections at the edges. Both the upper part 1 and the lower part 2 each have a shank portion 3, 4 and a paw portion 5, 6, wherein the upper part 1 and the lower part 2 are connected at the edges so as to form a shank 7 with an open shank end 8 and an adjacent closed paw holder 9 located at the side of the shank 7 opposite the shank end 8.

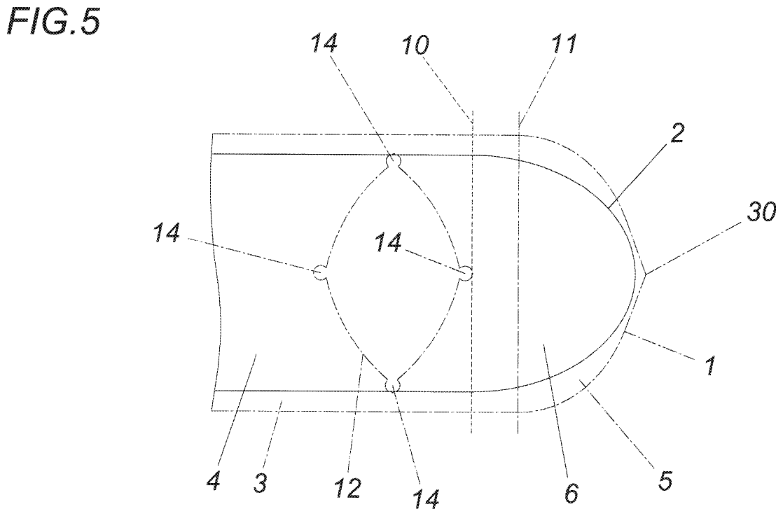

According to the invention, both the paw portion 6 of the lower part 2 and the paw portion 5 of the upper part 1 are formed in semi-oval shape adjoining, with the longitudinal or transversal axis thereof, respectively, the respective shank portion 3, 4 of the upper part 1 or the lower part 2, respectively. The paw portion 6 of the lower part 2 is formed in semi-oval shape adjoining, along the transversal axis 10 thereof, the shank portion 4 of the lower part 2, and the paw portion 5 of the upper part 1 is formed in semi-oval shape adjoining, along the longitudinal axis 11 thereof, the shank portion 3 of the upper part 1. The longitudinal axis 11 of the upper part 1 and the transversal axis of the lower part 2 are in parallel, as can be seen in detail from FIG. 5 in particular.

To avoid wrong running movements or even a twist or rolling-over of the paw into the wrong direction during wear of the paw protection, the semi-oval adjoining, along the longitudinal axis 11 thereof, the shank portion of the upper part 1 has, at the end of its transversal axis facing away from the shank portion 4, an end portion 30 tapered to form an apex. As a consequence, the paw holder curves slightly upwards in the front end portion 30 facing away from the shank 7, so as to guarantee that during running movements, it is always the lower part 2 that comes into bearing contact with the ground, and to avoid rolling-over on to the upper part 1 of the device.

In the illustrated embodiment, the shank portion 3 of the upper part 1 is penetrated by an oval 12, which is closed off by a cover part 13 circumferentially resting on the upper part 1 as reinforcement. In order to avoid the formation of folds during curvature of the oval cut-out, which inevitably occurs in the paw protection according to the invention, the end portions of the longitudinal and transversal axes of the oval 12 may be complemented by cut-outs 14 in the shank portion 3 of the upper part 1. In the embodiment illustrated in the figures, the cover part 13 has a plurality of scattered vent openings 15 which are water-tightly closed with a breathable membrane 16. The intended plurality of vent openings 15 prevents unintentional formation of folds.

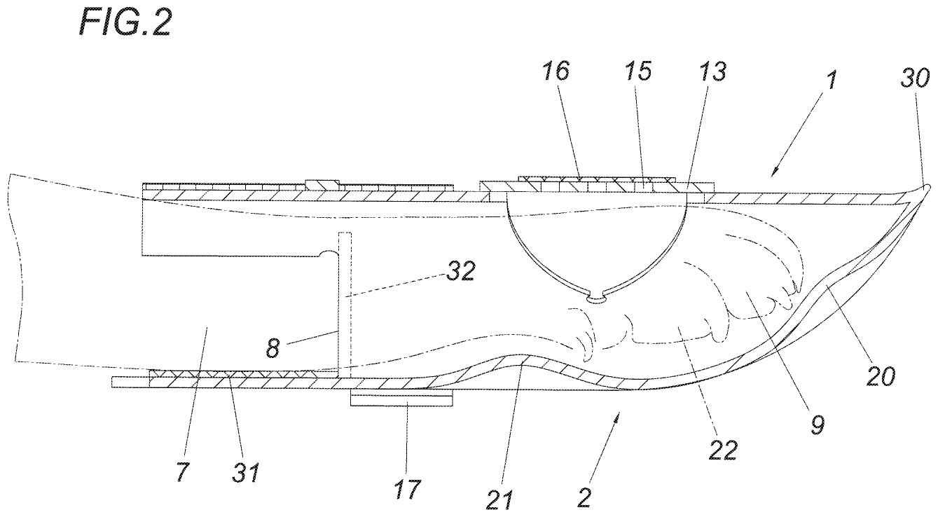

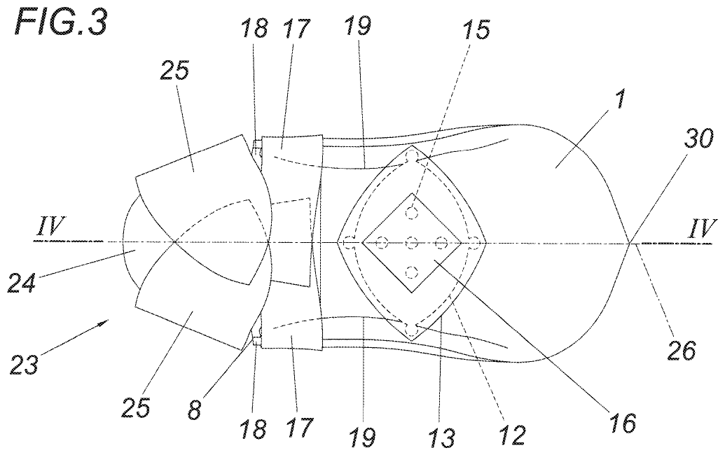

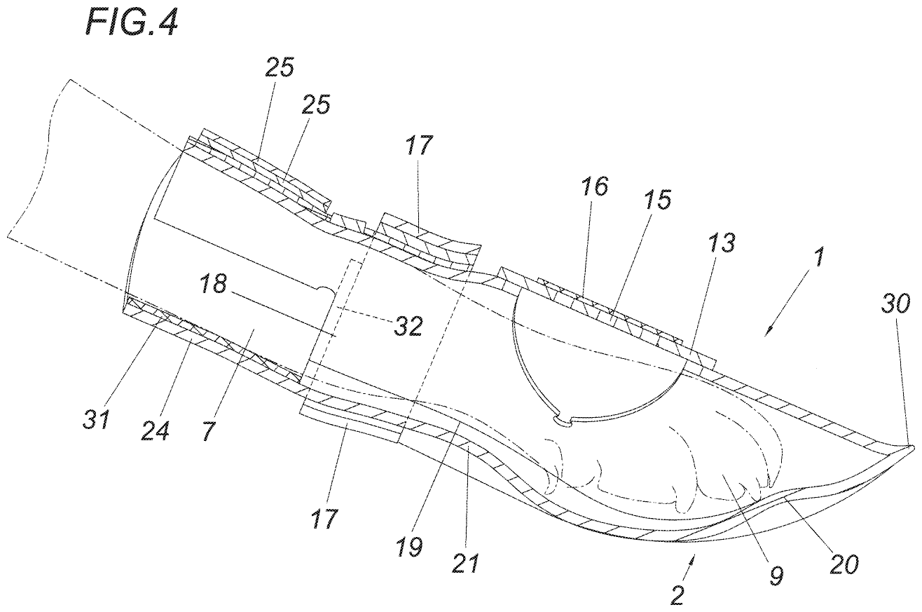

In order to enable adjustment of the device according to the invention to different paw sizes, two tension fasteners 17 connecting the upper part 1 and the lower part 2 are intended to be located in the area of the open shank end 8; which tension fasteners 17 are configured as hook-and-loop fasteners in the illustrated embodiment. When closing the tension fasteners 17 as illustrated in FIG. 3, the lateral transitional area between upper part 1 and lower part 2 may, in a closed state, be folded to form a fold 18, as illustrated in FIGS. 3 and 4. Reinforcement of the upper part 1 by the cover part 13 causes the folded material of the upper part 1 and the lower part 2 to form only two foldings 19 immediately adjacent to the tension fasteners 17, which prevents disadvantageous formation of folds in the area of the paw holder 9. In the area of the paw holder 9, only the paw portion 6 of the lower part 2 forms a concave indentation 20 between its front limit through the semi-oval and the transversal axis 10 as transitional area to the shank portion 4. Another concave indentation 21 is formed in the shank portion 4 of the lower part 2. Both indentations 20, 21 cause a particularly good fit of the device according to the invention to the anatomy of an animal paw 22, as can be seen in detail in FIGS. 2 and 4. In order to avoid tear at edge portions which are under particular mechanical stress, these may, depending on the material used, be protected by material reinforcement, such as adhered end strips 32.

In order to avoid unintentional detachment of the paw protection or peel-off through external influence, the illustrated embodiment includes slip-off protection 23, to which the open shank end 8 of the lower part 2 is extended. Said slip-off protection 23 comprises a base part 24 with two adjacent wing-shaped closing parts 25 which may be closed around the animal paw 22 by forming a conus tapered away from the shank 7, as can be seen from FIG. 3. To improve conus formation, both closing parts 25 may be configured to be adjacent to the base part 24 and inclined to the shank axis 26. The closing parts 25 are equipped with a hook-and-loop fastener in order to connect them with one another and with a respective connecting part 27 of the upper part 1, which to that purpose is also equipped with a hook-and-loop fastener. To improve the efficiency of the slip-off protection 23, it may in sections on the inside be equipped with a non-slip coating 31 which also serves as rubbing protection. To prevent tear of the slip-off protection 23, the wing-shaped closing parts 25 are, as described above, not formed integrally with the base part 24 but are adhered to the latter at a plurality of adhesion locations 32.

In order to be able to avoid the formation of folds and wear and tear in the area of slip-off protection as well, the edge portions of the slip-off protection 23 or its base-part 24 are, in the illustrated embodiment, configured to have circular-shaped cut-outs 28 at the transition to the shank portion 4 of the lower part 2.

What is claimed is:

1. A device for protecting paws, which comprises:
an upper part and a lower part, each having a shank portion and a paw portion, wherein the upper and lower parts are connected in sections at the edges, forming a shank and a paw holder adjacent to the shank, wherein the paw portion of the lower part is in semi-oval shape adjoining, along the transversal axis thereof, the shank portion of the lower part, and wherein the paw portion of the upper part is in semi-oval shape adjoining, along the longitudinal axis thereof, the shank portion of the upper part.

2. The device according to claim 1, wherein both semi-ovals are arranged symmetrically with respect to the shank axis, and wherein the semi-oval adjoining, along the longitudinal axis thereof, the shank portion of the upper part has, at the end of its transversal axis facing away from the shank portion, an end portion tapered to form an apex.

3. The device according to claim 1, wherein the shank portion of the upper part has a reinforcement.

4. The device according to claim 3, wherein the shank portion of the upper part is penetrated by an oval which is closed off by a cover part circumferentially resting on the upper part as reinforcement and which is complemented by cut-outs in the shank portion of the upper part, in the area of the end portions of the longitudinal and transversal axes thereof.

5. The device according to claim 4, wherein the cover part has a vent opening sealed with a breathable membrane.

6. The device according to claim 1, further comprising two tension fasteners connecting the upper part to the lower part located in the area of the open shank end on the outside of the shank.

7. The device according to claim 1, wherein the shank portion of the lower part is extended beyond the open shank end toward a slip-off protection, which in closed position, is tapered conically away from the shank.

8. The device according to claim 7, wherein the slip-off protection is equipped with a non-slip coating in sections on the inside.

9. The device according to one of the claim 1, wherein the upper and lower parts (1, 2) are made from polyurethane foam.

10. The device according to claim 9, wherein the polyurethane foam has a material thickness of 1-3 mm and a tensile strength of about 8.1 N/mm².
